(19) United States
(12) Patent Application Publication
(10) Pub. No.: US 2010/0086743 A1
(43) Pub. Date: Apr. 8, 2010

(54) COMPOSITE OPTICAL FILM

(75) Inventors: Hsung-Hsing Wang, Kaohsiung (TW); Sue-Hong Liu, Kaohsiung (TW); Po-Wen Lin, Kaohsiung (TW); Pei-Hsin Chen, Kaohsiung (TW)

Correspondence Address: LADAS & PARRY LLP, 26 WEST 61ST STREET, NEW YORK, NY, 10023, US

(73) Assignee: ETERNAL CHEMICAL CO., LTD.

(21) Appl. No.: 12/564,103

(22) Filed: Sep. 22, 2009

(30) Foreign Application Priority Data
Oct. 2, 2008 (TW) 097137998

(51) Int. Cl. B32B 3/00

(52) U.S. Cl. 428/172

(57) ABSTRACT

The present invention relates to a composite optical film, which comprises a substrate having diffusion micro-structures and a structured surface on one side of the substrate wherein said composite optical film has an internal diffusion haze of no less than 5% as measured according to JIS K7136 standard method. The composite optical film of the present invention has both light-diffusion and light-converging properties. The composite optical film of the present invention, when utilized in a liquid crystal display (LCD), can not only effectively enhance the luminance of the LCD panel but also avoid light dispersion and Moiré phenomena that may occur when said composite optical film is stacked with other material films.

### BACKGROUND OF THE INVENTION

1. Field of the Invention

The present invention relates to a composite optical film, particularly, a composite optical film for use in liquid crystal displays. The composite optical film of the present invention has both light-diffusion and light-converging properties and can reduce light dispersion and Moiré phenomena that may occur when said composite optical film is stacked with other material films.

2. Description of the Prior Art

In general, a liquid crystal display (LCD) is mainly composed of a panel and a backlight module. The panel comprises, for example, indium tin oxide (ITO) conductive glass, liquid crystals, an alignment film, a color filter, a polarizer and a driving integrated circuit. The backlight module comprises, for example, lamps, a light guide plate, and various optical films. Since a liquid crystal panel does not emit light itself, a backlight module, as a brightness source, is an important element for the displaying function of a LCD, and is very important for enhancing the brightness of a LCD. Presently, various optical films are used in the backlight module, and the use of such various optical films has become the most economical and convenient solution to enhance the brightness of a LCD panel to optimize the service efficiency of the light source without altering any element design or consuming additional energy.

FIG. 1 is a schematic diagram of various optical films contained in a backlight module. As shown in FIG. 1, the optical films contained in a common backlight module include: a reflective film (1) disposed below the light guide plate (2); and other optical films disposed above the light guide plate (2), i.e., from the bottom to the top, a diffusion film (3), light converging films (4) and (5), and a protective diffusion film (6) in sequence.

The main function of a light converging film, also referred to as brightness enhancement film or prism film in the industry, is to gather the scattered light rays by refraction and internal total reflection and converge the light rays in the on-axis direction of about ±35 degrees to enhance the luminance of LCDs. Normally, the light converging film converges light by means of regularly arranged linear prism structures.

FIG. 2 is a schematic diagram of a conventional light converging film, which comprises a substrate 21 and a plurality of prism structures 22 on the substrate 21. The prism structures are parallel to each other and each prism structure is composed of two slanted surfaces. The two slanted surfaces meet at the top of the prism to form a peak 23, each of which meets with another slanted surface of an adjacent prism to form a valley 24. Since the light converging film comprises regularly arranged columnar structures with constant widths, the light rays from the light converging film are liable to optically interfere with the reflected or refracted light rays from other films of the display or with other light rays refracted or reflected by the light converging film itself, thereby resulting in rainbow effect, bright and dark stripes, Moiré or Newton ring in the LCD. Presently, a protective diffusion film (or referred to as “top diffuser”) is known to be disposed on the light converging film to eliminate the above optical phenomena. However, a top diffuser is expensive and an extra optical film will increases the thickness and complexity of the backlight module such that the backlight module cannot meet the current requirements for light and thin devices.

Therefore, it is desired in the industry to provide an optical film that can eliminate the above optical phenomena and are more economical.

### SUMMARY OF THE INVENTION

By extensive studies, the inventors of the present invention found a composite optical film that possesses both light-diffusion and light-converging properties so as to effectively enhance the efficiency of light, and is thinner so as to make the assembly of backlight modules easier.

The primary object of the present invention is to provide a composite optical film effective in eliminating rainbow effect, which comprises a substrate having diffusion micro-structures and a structured surface on one side of the substrate wherein said composite optical film has an internal diffusion haze of no less than 5% as measured according to JIS K7136 standard method.

### BRIEF DESCRIPTION OF THE DRAWINGS

FIG. 1 is a schematic diagram of various optical films contained in a backlight module.

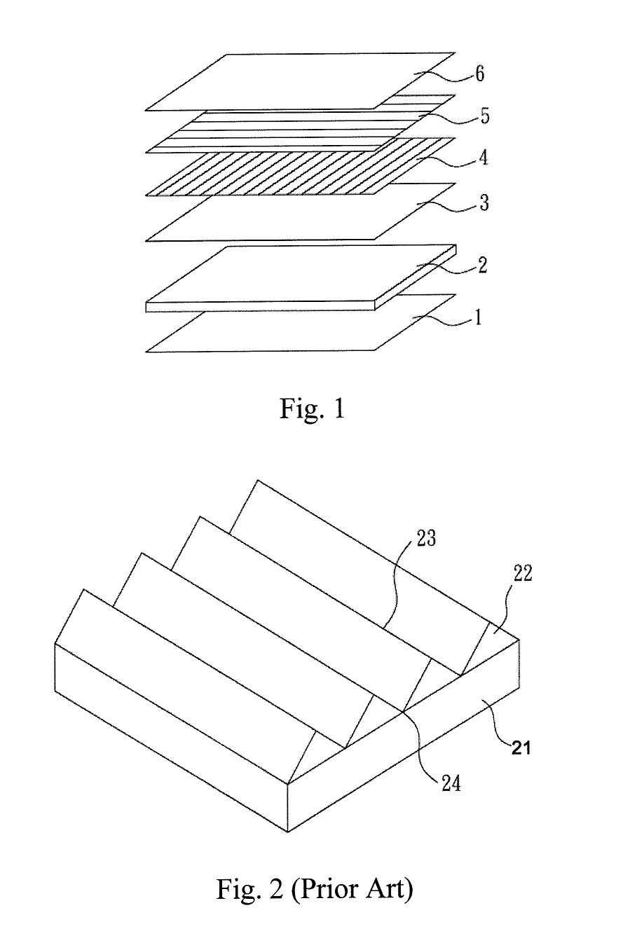

FIG. 2 is a schematic view of a conventional light-converging film.

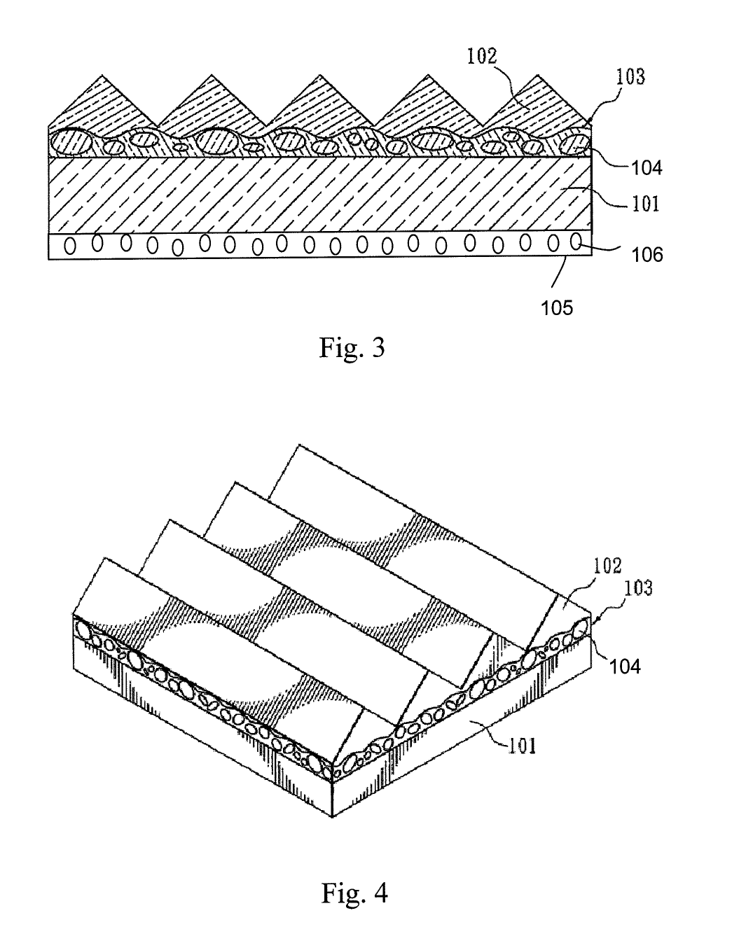

FIGS. 3 to 6 are schematic views of the preferred embodiments of the composite optical film according to the present invention.

### DETAILED DESCRIPTION OF THE INVENTION

It should be noted that the terminology used in the description is for the purpose of describing the embodiments only and not intended to limit the protection scope of the present invention. For example, as used herein, the terms “a,” “an,” and “the” include singular and plural references unless the context clearly indicates otherwise.

The term “columnar structure” used herein refers to a multi-peak columnar structure or a single-peak columnar structure.

The term “multi-peak columnar structure” used herein refers to a union structure formed from at least two columnar structures overlapping with each other and the height of the valley line between any two adjacent columnar structures is 30% to 95% of the height of the lower of the two adjacent columnar structures.

The term “single-peak columnar structure” used herein refers to a structure formed from a single columnar structure and having only one peak.

The term “prism columnar structure” used herein refers to a prism columnar structure composed of two slanted surfaces. The slanted surfaces can be curved surfaces or plane surfaces. The two slanted surfaces meet at the top of the prism to form a peak, each of which meets with another slanted surface of an adjacent columnar structure to form a valley.

The term “arc columnar structure” used herein refers to an arc columnar structure composed of two slanted surfaces. The two slanted surfaces meet at the top where they are blunted to form a curved surface and each of the two slanted surfaces meets with another slanted surface of an adjacent columnar structure to form a valley.

The term “linear columnar structure” used herein refers to a columnar structure where the ridge thereof is extended as a straight line.

The term “serpentine columnar structure” used herein refers to a columnar structure having a serpentine ridge. The serpentine columnar structure has at least one serpentine surface, and the curvature of the serpentine surface varies properly and the variation of the curvature is from 0.2% to 100%, preferably from 1% to 20% on the basis of the height of the serpentine columnar structure.

The term “internal diffusion haze” used herein refers to a haze value (Hz) of an optical film measured according to JIS K7136 standard method after the structured surface of an optical film is filled with a resin having a refractive index (n) of 1.55 and cured.

The composite optical film according to the present invention comprises a substrate having diffusion micro-structures. Said substrate can be composed of a single layer or multiple layers and can be any substrate known to persons having ordinary skill in the art, such as a glass substrate or a plastic substrate. The species of the resins used to form the plastic substrate are not particularly limited, and can be, for example, but are not limited to: polyester resins, such as polyethylene terephthalate (PET) and polyethylene naphthalate (PEN); polyacrylate resins, such as polymethyl methacrylate (PMMA); polyolefin resins, such as polyethylene (PE) or polypropylene (PP); polycycloolefin resins; polyimide resins; polycarbonate resins; polyurethane resins; triacetate cellulose (TAC); polylactic acid (PLA); or a mixture thereof. Polyester resins, polycarbonate resins, or a mixture thereof are preferred and polyethylene terephthalate is more preferred. The thickness of the substrate of the present invention is preferably in the range from 15 μm to 300 μm, usually depending on the desired purpose of an optical product.

The substrate of the composite optical film according to the present invention has diffusion micro-structures and has a haze in the range from 30% to 70%, preferably from 45% to 60%, as measured according to JIS K7136 standard method. The diffusion micro-structures and the substrate can be formed integrally by, for example, pad printing, embossing, transfer printing, injection or biaxial stretching. Alternatively, the diffusion micro-structures can be formed by processing the substrate by any conventional method, for example, by coating, spray coating or roughening. For example, the diffusion micro-structures can be formed by applying a coating on the substrate and then carving the coating to form desired convex-concave microstructures, or by applying a coating containing a foaming agent on the substrate and then foaming the coating, or by applying a coating containing beads on the substrate. The thickness of the diffusion micro-structure layer is not particularly limited. It depends on the size of the diffusion micro-structures and is generally in the range from about 1 μm to about 100 μm, preferably in the range from about 2 μm to about 50 μm, and more preferably in the range from about 3 μm to about 15 μm.

According to one preferred embodiment of the present invention, the diffusion micro-structures are formed by applying a coating composition comprising beads, a binder and optionally a curing agent onto one surface of the substrate by utilizing a continuous roll-to-roll technique.

The species of the beads suitable for the present invention are not particularly limited, and can be for example, glass beads; metal oxide beads, such as TiO₂, SiO₂, ZnO, Al₂O₃, ZrO₂, or a mixture thereof; plastic beads, for example but are not limited to, acrylate resin, styrene resin, urethane resin, silicone resin, or a mixture thereof, of which acrylate resin or silicone resin or a combination thereof is preferred. The shape of the beads suitable for the present invention is not particularly limited, which can be, for example, spherical, diamond-like, oval, rice-like or biconvex lenses-shaped, of which the spherical shape is preferred. The average particle size of the beads is ranging from about 1 μm to about 50 μm, preferably from about 2 μm to about 30 μm, and more preferably from about 3 μm to about 10 μm. The beads have a refractive index of 1.3 to 2.5, preferably of 1.4 to 1.6. The beads are present in an amount from 0.1 to 30 parts by weight per 100 parts by weight of the solids content of the binder. In addition, the distribution of the beads in the diffusion micro-structures is not particularly limited, and preferably, the beads are uniformly distributed in the diffusion micro-structures in a single layer. The single-layer uniform distribution can not only reduce the raw material cost, but also reduce the wastes of the light source, thereby enhancing the luminance of the composite optical film.

The binder suitable for the present invention is preferably colorless and transparent so as to allow light rays to transmit through. The binder of the present invention can be a thermal setting resin, an energetic ray curable resin or a combination thereof. The energetic rays refer to a light source in a certain wavelength range, which can be, for example, ultraviolet (UV) light, infrared radiation (IR), visible light, or heat ray (radiant heat or radioactive heat). The irradiation intensity can be from 1 to 500 mJ/cm², preferably from 50 to 300 mJ/cm². The species of the binder are not particularly limited, which can be any binder well known to persons having ordinary skill in the art, for example, but are not limited to an acrylate resin, a polyamide resin, an epoxy resin, a fluoro resin, a polyimide resin, a polyurethane resin, an alkyd resin, a polyester resin, or a mixture thereof, of which the acrylate resin, polyurethane resin, polyester resin, or a mixture thereof is preferred.

The curing agent suitable for the present invention can be any curing agent well known to persons having ordinary skill in the art and capable of making the molecules to be chemically bonded with each other to form crosslinking, and can be, for example, but is not limited to diisocyanate or polyisocyanate. The commercially available curing agents include, for example, Desmodur 3390 produced by Bayer Company.

The composite optical film according to the present invention comprises a substrate having diffusion micro-structures and a structured surface on one side of the substrate, wherein said composite optical film has an internal diffusion haze of no less than 5%, preferably in the range of 5% to 40%. The method utilized to measure the internal diffusion haze is as described hereinbefore. When the internal diffusion haze is less than 5%, the rainbow effect cannot be effectively eliminated, and when the internal diffusion haze is greater than 40%, the light transmission of the composite optical film is not good, thereby reducing the luminance. The factors that affect the internal diffusion haze include the species and proportions of the breads and the binder, the species of the resin for forming the structured surface, and so on. For example, a composite optical film having a desired internal diffusion haze can be obtained by selecting suitable species for the beads and binder and controlling the proportions thereof, thereby enhancing diffusion effect and effectively eliminating rainbow effect. In addition, the greater the absolute value of the difference between the refractive index of the beads in the diffusion micro-structures and that of the structured surface is, the better the internal diffusion effect will be obtained. Preferably, the absolute value of the difference between the refractive indices is in the range from about 0.03 to about 1.2.

The structured surface according to the present invention comprises a plurality of micro-structures having light-converging effect. The structured surface according to the present invention can be formed by any method well known to persons having ordinary skill in the art. For example, the structured surface can be formed by directly laminating one or more micro-structure layers on the substrate having diffusion micro-structures of the present invention, such as, directly laminating a commercially available light-converging film on the substrate having diffusion micro-structures of the present invention. The commercially available light-converging films suitable for the present invention include those with the trade name BEF90HP or BEF II 90/50, produced by Sumitomo 3M Company; and those with the trade name DIA ART H150100® or P210, produced by Mitsubishi Rayon Company. Alternatively, the structured surface comprising a plurality of micro-structures having light-converging effect can be formed on the substrate by a coating method.

According to one preferred embodiment of the present invention, the structured surface comprising a plurality of micro-structures having light-converging effect can be formed by applying a resin coating onto one side of the substrate with a roll-to-roll continuous process and by slit die coating, micro gravure coating, or roller coating method to so as to form the structured surface.

According to one preferred embodiment of the present invention, the structured surface is formed on the side of the substrate that comprises diffusion micro-structures.

The structured surface of the present invention is composed of a coating layer formed from a resin coating which, after being cured, has a refractive index higher than that of air. In general, the higher the refractive index is, the higher the luminance will be obtained. The structured surface of the present invention has a refractive index of at least 1.50, preferably from 1.53 to 1.65. The resin coating comprises a thermal setting resin, an energetic ray curable resin or a combination thereof, of which the energetic ray curable resin is preferred. The energetic ray is as described hereinbefore. The resin coating may optionally comprise a photoinitiator, a crosslinking agent, and other additives.

According to one preferred embodiment of the present invention, the resin coating comprises a UV curable resin, a photoinitiator, and a crosslinking agent. The UV curable resin useful for the present invention can be, for example but is not limited to, (meth)acrylate resins. The species of the (meth)acrylate resins include, for example but are not limited to, a (meth)acrylate resin, a urethane acrylate resin, a polyester acrylate resin, an epoxy acrylate resin, and a mixture thereof, of which the (meth)acrylate resin is preferred.

The monomers used to form the UV curable resin of the present invention can be selected from the group consisting of epoxy diacrylate, halogenated epoxy diacrylate, methyl methacrylate, isobornyl acrylate, 2-phenoxy ethyl acrylate, acrylamid, styrene, halogenated styrene, acrylic acid, (meth)acrylonitrile, fluorene derivative diacrylate, biphenylepoxyethyl acrylate, halogenated biphenylepoxyethyl acrylate, alkoxylated epoxy diacrylate, halogenated alkoxylated epoxy diacrylate, aliphatic urethane diacrylate, aliphatic urethane hexaacrylate, aromatic urethane hexaacrylate, bisphenol-A epoxy diacrylate, novolac epoxy acrylate, polyester acrylate, polyester diacrylate, acrylate-capped urethane, and a mixture thereof. Preferably, the monomers are selected from the group consisting of halogenated epoxy diacrylate, methyl methacrylate, 2-phenoxy ethyl acrylate, aliphatic urethane diacrylate, aliphatic urethane hexaacrylate, aromatic urethane hexaacrylate, and a mixture thereof.

The photoinitiators suitable for the invention are not particularly limited, which can be, for example, selected from the group consisting of benzophenone, benzoin, benzil, 2,2-dimethoxy-1,2-diphenylethan-1-one, 1-hydroxy cyclohexyl phenyl ketone, 2,4,6-trimethylbenzoyl diphenyl phosphine oxide (TPO), and a mixture thereof, of which benzophenone is preferred.

The crosslinking agent suitable for the invention can be a monomer or oligomer having one or more functional groups, of which the monomer or oligomer having more functional groups is preferred because it can effectively enhance the glass transition temperature of the resin coating. The species of the crosslinking agent are well known to persons having ordinary skill in the art, which can be, for example, but are not limited to (meth)acrylate; urethane acrylate such as aliphatic urethane acrylate, aliphatic urethane hexaacrylate, or aromatic urethane hexaacrylate; polyester acrylate such as polyester diacrylate; epoxy acrylate such as bisphenol-A epoxy diacrylate; novolac epoxy acrylate; or a mixture thereof. The above-mentioned (meth)acrylate may have two or more functional groups, of which the (meth)acrylate that has more functional groups is preferred. Examples of the (meth)acrylate suitable for the present invention include, but are not limited to tripropylene glycol di(meth)acrylate, 1,4-butanediol di(meth)acrylate, 1,6-hexanediol di(meth)acrylate, polyethyleneglycol di(meth)acrylate, allylated cyclohexyl di(meth)acrylate, isocyanurate di(meth)acrylate, ethoxylated trimethylol propane tri(meth)acrylate, propoxylated glycerol tri(meth)acrylate, trimethylol propane tri(meth)acrylate, tris(acryloxyethyl) isocyanurate, or a mixture thereof. The commercially available (meth)acrylate crosslinking agents suitable for the present invention include those with the trade name SR454®, SR494®, SR9020®, SR9021® or SR9041®, produced by Sartomer Company; that with the trade name 624-100®, produced by Eternal Company; and those with the trade name Ebecryl 600®, Ebecryl 830®, Ebecryl 3605® or Ebecryl 6700®, produced by UCB Company.

In order to enhance the hardness of the coating formed after being cured, inorganic fillers can be optionally added to the resin coating of the present invention to avoid the change of optical properties due to the collapse of the micro-structures on the structured surface. In addition to enhancing the hardness of the coating formed after being cured, the inorganic fillers can also enhance the brightness of LCD panels. The inorganic fillers suitable for the present invention can be any inorganic fillers known to persons having ordinary skill in the art, which can be, for example, but are not limit to zinc oxide, silicon dioxide, strontium titanate, zirconia, alumina, calcium carbonate, titanium dioxide, calcium sulfate, barium sulfate, or a mixture thereof, of which titanium dioxide, zirconia, silicon dioxide, zinc oxide, or a mixture thereof is preferred. The inorganic fillers have a particle size from about 10 nm to about 350 nm, preferably from 50 nm to 150 nm.

According to the present invention, other conventional additives can be optionally added to the resin coating to adjust the physical or chemical properties as needed. Said additives can be, for example, but are not limited to an anti-static agent, a slip agent, a leveling agent, a defoamer or a mixture thereof.

The thickness of the structured surface of the present invention is in the range of 5 μm to 100 μm. The types of the micro-structures on the structured surface are well known to persons having ordinary skill in the art, which can be, for example, but are not limited to regularly or irregularly arranged, columnar structures, conical structures, solid angle structures, orange-segment like structures, lens-like structures, or capsule-like structures, or a combination thereof, of which regularly or irregularly arranged columnar structures are preferred. The columnar structures can be linear, serpentine, or zigzag, and two adjacent columnar structures can be parallel or non-parallel to each other. The height of the peak of a columnar structure may change along the extension direction of the columnar structure or not. The height of the peak of a columnar structure changing along the extension direction of the columnar structure means that at least a portion of the columnar structure changes in height randomly or regularly along the principal axis of the structure. The magnitude of variation in height is at least 3% of the nominal height (or an average height), preferably from 5% to 50% of the nominal height of the structure.

The columnar structures used in the present invention can be the same or different in height and width. The heights of the structures depend on the desired purpose of an optical product, and are generally in the range from 5 μm to 100 μm, preferably in the range from 10 μm to 50 μm, and more preferably in the range from 10 μm to 40 μm. The columnar structures can be single-peak columnar structures, multi-peak columnar structures or a combination thereof. Preferably, the columnar structures are symmetrical columnar structures so as to simplify the processing procedures and control of light-converging effect more easily.

The columnar structures used in the present invention can be prism columnar structures, arc columnar structures, or a combination thereof, of which prism columnar structures are preferred. When the columnar structures are arc columnar structures, the curvature radius of the highest point of the curved surface on the top of each arc columnar structure is in the range from 2 μm to 50 μm, preferably in the range from 2 μm to 35 μm, and more preferably in the range from 2 μm to 10 μm. The apex angles of the prism columnar structures or the arc columnar structures used in the present invention can be the same or different, and are in the range from 40° and 120°, preferably in the range from 60° and 120°. In order to possess both scratch resistance and high brightness, the apex angles of the prism columnar structures are preferably in the range from 80° and 120° and the apex angles of the arc columnar structures are preferably in the range from 60° and 110°.

During the movement or transportation, the surface of a composite optical film may be scratched or worn due to improper operations, thereby affecting the optical effect thereof. To avoid the above disadvantage, according to the present invention, a scratch-resistant layer can be optionally formed on the side opposite to the structured surface of the substrate by applying thereto a hard coat solution comprising a thermal setting resin and/or a UV curable resin, followed by curing the coating solution with heat and/or UV irradiation. The scratch-resistant layer of the present invention has a pencil hardness of 3H or more as measured according to JIS K5400 standard method. The thickness of the scratch-resistant layer of the present invention is in the range from about 0.5 μm to 30 μm, preferably in the range from 1 μm to 10 μm. Beads can be optionally added to the hard coat solution, such that the scratch-resistant layer has a certain extent of light-homogenizing effect for eliminating bright and dark stripes. The species and shapes of the beads suitable for the scratch-resistant layer of the present invention are as described hereinbefore. The particle size of the beads suitable for the scratch-resistant layer of the present invention is preferably in the range from 1 μm to 30 μm. In the scratch-resistant layer, the beads are present in an amount from about 0.1 to about 10 parts by weight per 100 parts by weight of the solids content of the resin. In addition, the scratch-resistant layer of the present invention can be smooth or non-smooth. In addition to being formed by coating a hard coat solution, the scratch-resistant layer can be formed by other conventional methods, which can be, for example, but are not limited to, screen printing, spray coating, or embossing processing. In the case that no structures are present on the other side of the substrate, the scratch-resistant layer will have a haze no less than 3% as measured according to JIS K7136 standard method.

According to one preferred embodiment of the present invention, a scratch-resistant layer comprising beads is applied onto the light incidence surface of the composite optical film. The scratch-resistant layer possesses excellent anti-static property and high hardness property, and can prevent the optical film from being scratched or damaged during transportation or processing and from being adhered by dusts. Furthermore, the scratch-resistant layer has high transparency, such that it will not adversely affect the optical properties.

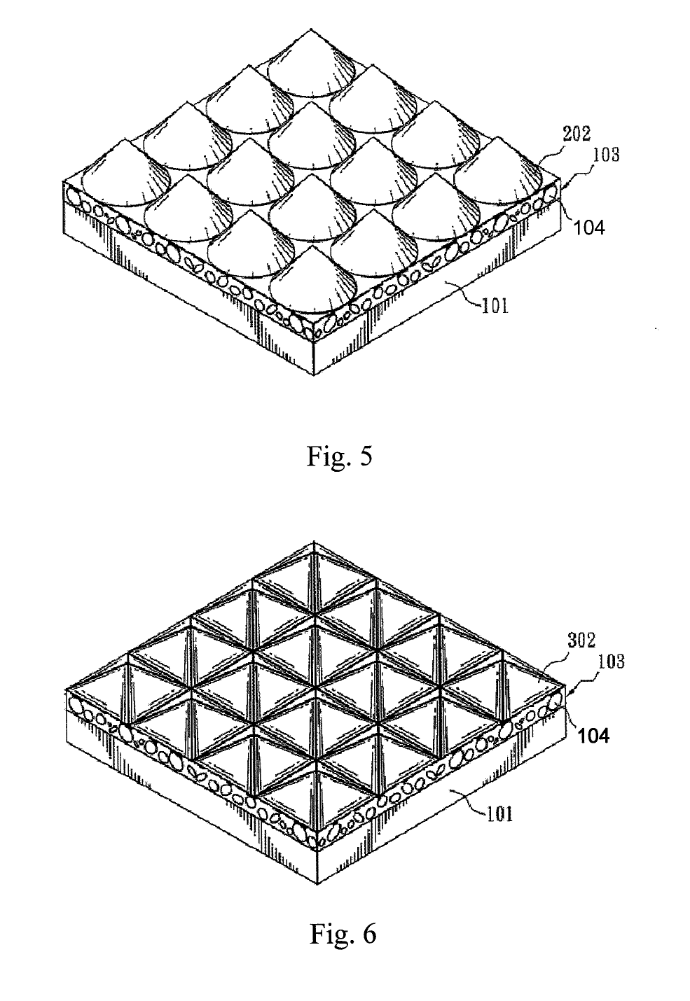

FIG. 3 is a schematic view of one preferred embodiment of the composite optical film according to the present invention, wherein the composite optical film comprises a substrate 101 having diffusion micro-structures 103, the diffusion micro-structures 103 contain beads 104 and a structured surface 102 thereon, and the structured surface has a plurality of prism columnar micro-structures. In addition, the composite optical film shown in FIG. 3 has a scratch-resistant layer 105 on the side opposite to the structured surface of the substrate. The scratch-resistant layer contains beads 106.

FIGS. 4-6 are schematic views of the preferred embodiments of the composite optical films according to the present invention wherein each of the composite optical film comprises a substrate 101 having diffusion micro-structures 103 and the diffusion micro-structures 103 contain beads 104 and have a structured surface 102, 202 or 302 thereon. The structured surfaces 102, 202 and 302 of the composite optical films shown in FIGS. 4-6 have a plurality of prism columnar micro-structures, lens-like micro-structures and solid angle micro-structures, respectively.

The composite optical film of the present invention has a total transmittance of no less than 60% as measured according to JIS K7136 standard method, and as described hereinbefore, the composite optical film has an internal diffusion haze of no less than 5%, preferably in the range from 5% to 40%, as measured according to JIS K7136 standard method. Both of the micro-structure layer and the scratch-resistant layer of the composite optical film of the present invention have a surface resistivity less than 10¹³ Ω/□ (Ω/□ represents ohm/square), preferably in the range from 10⁸ to 10¹² Ω/□.

The composite optical film of the present invention can be used in light source devices, for example, advertising light boxes or flat panel displays. The composite optical film according to the present invention can effectively eliminate rainbow effect in view of the diffusion micro-structures on the substrate. When the composite optical film has a scratch-resistant layer, it can further improve the moiré phenomenon resulting from the regular arrangement of optical films, eliminate bright and dark stripes, and enhance the uniformity of light by the light homogenizing effect provided by the scratch-resistant layer. In addition, in the embodiment of a composite optical film having a scratch-resistant layer comprising beads, since the scratch-resistant layer has good static resistance and high hardness, it can protect the composite optical film without the need of adhering any additional protective film, so that the steps of adhering and tearing the protective film can be obviated, thereby enhancing the ease of assembling a backlight module and reducing the cost.

The following examples are used to further illustrate the present invention, but not intended to limit the scope of the present invention. Any modifications or alterations that can be easily accomplished by persons skilled in the art fall within the scope of the disclosure of the specification and the appended claims.

### Preparation of a Substrate Having Diffusion Micro-Structures

Coatings were prepared using components A, B, C and D in the amounts provided in Table 1, and respectively applied onto one side of a transparent PET film having a thickness of 188 μm [U34®, Toray Company] by a Bar Coater. After drying, the substrates having diffusion micro-structures and a thickness of about 198 μm were obtained, and the resultant substrates have a haze of 25%, 50% and 90%, respectively.

TABLE 1

| | | | |
|---|---|---|---|
| A (gram) | 22 | 22.8 | 22.8 |
| B (gram) | 21.04 | 19.5 | 18.5 |
| C (gram) | 0.96 | 1.68 | 2.7 |
| D (gram) | 56 | 56 | 56 |
| haze of the substrate | 25% | 50% | 90% |

Component A: a binder under the trade name Eterac 7363-ts-50, produced by Eternal Company.
Component B: a curing agent under the trade name Desmodur 3390, produced by Bayer Company.
Component C: beads under the trade name SSX-105 and having an average particle size of about 5 μm, produced by Sekisui Company.
Component D: a solvent of methyl ethyl ketone:toluene = 1:1.

### Comparative Example 1

### Conventional Brightness Enhancement Film

An optical film was prepared by applying an acrylate resin coating layer of a thickness of about 15 μm onto a transparent PET film, forming prism structures on the coating layer by roller embossing, and then curing the structures by high energy UV light.

### Comparative Example 2

### Conventional Brightness Enhancement Film

A commercially available brightness enhancement film, BEF III (3M Company).

### Comparative Example 3

### Conventional Brightness Enhancement Film with a Coating on the Back Side of the Substrate

A commercially available brightness enhancement film, BEF III M (3M Company).

### Comparative Example 4

An optical film was prepared by applying an acrylate resin coating layer of a thickness of about 15 μm onto the diffusion micro-structures of the substrate that has a haze of 25% as recorded in Table 1, forming prism structures on the coating layer by roller embossing, and then curing the structures by high energy UV light.

### Example 1

A composite optical film according to the present invention was prepared by applying an acrylate resin coating layer of a thickness of about 15 μm onto the diffusion micro-structures of the substrate that has a haze of 50% as recorded in Table 1, forming prism structures on the coating layer by roller embossing, and then curing the structures by high energy UV light.

### Example 2

A composite optical film according to the present invention was prepared by applying an acrylate resin coating layer of a thickness of about 15 μm onto the diffusion micro-structures of the substrate that has a haze of 90% as recorded in Table 1, forming prism structures on the coating layer by roller embossing, and then curing the structures by high energy UV light.

### Examples 3 to 5

In order to address the problem associated with bright and dark stripes and enhance the scratch resistance of the optical film, hard coat solutions were prepared with components E, F, G and H in the amounts provided in Table 2 for use in the preparation of scratch-resistant layers. Scratch-resistant layers with a thickness of about 5 μm were prepared by respectively applying the hard coat solutions made according to Table 2 onto the film made according to Example 1 on the side opposite to the structured surface. After drying, the composite optical films having a scratch-resistant layer according to the present invention were obtained.

The hard coat solutions made according to Table 2 were respectively applied onto transparent PET films having a thickness of 188 μm [U34®, Toray Company] to prepare scratch-resistant layers, and then, in the absence of any structures on the other side of the substrates, the haze values of the scratch-resistant layers were measured according to JIS K7136 standard method.

TABLE 2

| | Example 3 | Example 4 | Example 5 |
|---|---|---|---|
| E (gram) | 22 | 22 | 22 |
| F (gram) | 21.9 | 21.5 | 21.04 |
| G (gram) | 0.1 | 0.5 | 0.96 |
| H (gram) | 56 | 56 | 56 |
| haze of the | 3% | 15% | 25% |
| scratch-resistant layer | | | |

Component E: a binder under the trade name Eterac 7363-ts-50, produced by Eternal Company.
Component F: a curing agent under the trade name Desmodur 3390, produced by Bayer Company.
Component G: beads under the trade name SSX-105 and having an average particle size of about 2 μm, produced by Sekisui Company.
Component H: a solvent of methyl ethyl ketone:toluene = 1:1.

### Test Results

The films of Comparative Examples 1 to 4 and Examples 1 to 5 were subjected to visual inspection to observe rainbow effect and bright and dark stripes, to luminance measurement, and to internal diffusion haze measurement. The luminance measurement was conducted on the films by the BM-7® instrument of Topcon Company. A resin having a refractive index of 1.55 and containing 50% of 624M-70 (Eternal Company), 1.5% of EM2108 (Eternal Company), 8% of EM231 (Eternal Company), 1.5% of EM2380 (Eternal Company), 5% of EM52 (Eternal Company), 30% of A-LEN10 (Shin-Nakamura Company), 3.5% of 1184 (Ciba Company) and 0.5% of Rad 2300 (Tego Company) was spread over the films so as to fill the prism structures of the films and the internal diffusion haze of the films was measured according to JIS K7136 standard method after curing. The results were listed in Table 3.

TABLE 3

| | rainbow | bright and | | internal diffusion |
|---|---|---|---|---|
| | effect | dark stripes | luminance | haze |
| Comparative | yes | yes | 100% | 0.78% |
| Example 1 | | | | |
| Comparative | no | yes | 100% | 0.93% |
| Example 2 | | | | |
| Comparative | no | no | 96.9% | 26.8% |
| Example 3 | | | | |
| Comparative | yes | yes | 99.7% | 2.97% |
| Example 4 | | | | |
| Example 1 | no | yes | 99.6% | 15.19% |
| Example 2 | no | yes | 84.5% | 18.92% |
| Example 3 | no | slight | 98.7% | 7.34% |
| Example 4 | no | no | 97.4% | 29.86% |
| Example 5 | no | no | 96.9% | 35.51% |

### Discussions

Comparative Example 1 is directed to a conventional brightness enhancement film. The film of Comparative Example 1 has high luminance; however, it has the problems associated with rainbow effect and bright and dark stripes. The composite optical film of Example 1 obviously solves rainbow effect, and if used with a scratch-resistant layer, it can further solve the problem associated with bright and dark stripes without causing significant influence on luminance.

It can be seen from the results of Comparative Example 4 and Examples 1 and 2 that rainbow effect occurs when the internal diffusion haze of the optical films is less than 5%, and that the occurrence of rainbow effect can be avoided by using an optical film having a higher internal diffusion haze. However, it should be noted that an increased internal diffusion haze will reduce luminance. When the resin material of the structured surface and the species of the components of the diffusion micro-structures are selected, the internal diffusion haze is related to the haze of the substrate. The greater the haze of the substrate is, the greater of the internal diffusion of the optical film will be obtained. The required haze of the substrate can be obtained by adjusting the beads content in the diffusion micro-structures, and therefore, the desired composite optical film can be obtained.

It can be seen from the results of Examples 1 to 5 that whether rainbow effect occurs or not depends on the value of the internal diffusion haze of the films. The film of Comparative Example 4 has an internal diffusion haze of 2.97% and has obvious rainbow effect by visual inspection. When the internal diffusion haze increases to 7.34% (Example 3), rainbow effect can be avoided.

It can be seen from the results of Examples 3 to 5 that the composite optical films having a scratch-resistant layer on the back side can eliminate the phenomena of bright and dark stripes.

It can be seen from the results of Examples 3 to 5 listed in Table 3 that the haze degree of the scratch-resistant layer on the back side of the substrate will affect the occurrence of bright and dark stripes. As shown in Table 2, the scratch-resistant layer of Example 3 has a haze of about 3% and the film of Example 3 has slight bright and dark stripes by visual inspection. The scratch-resistant layers of Examples 4 and 5 have a haze of 15% and 25%, respectively, and the films of Examples 4 and 5 can completely eliminate bright and dark stripes.

As shown in Table 3, all of the optical films of Examples 4 and 5 and Comparative Example 3 have neither rainbow effect nor bright and dark stripes. However, the luminance values of the optical films of Examples 4 and 5 are higher than that of the commercially available brightness enhancement film of Comparative Example 3.

We claim:

1. A composite optical film comprising:
a substrate having diffusion micro-structures; and
a structured surface on one side of the substrate;
wherein said composite optical film has an internal diffusion haze of no less than 5% as measured according to JIS K7136 standard method.

2. The composite optical film as claimed in claim 1, which has an internal diffusion haze in the range from 5% to 40% as measured according to JIS K7136 standard method.

3. The composite optical film as claimed in claim 1, wherein the diffusion micro-structures are formed by applying a coating layer onto the substrate and then carving the coating to form the desired diffusion micro-structures.

4. The composite optical film as claimed in claim 1, wherein the diffusion micro-structures are formed by applying a coating comprising a foaming agent onto the substrate and then foaming the coating.

5. The composite optical film as claimed in claim 1, wherein the diffusion micro-structures are formed by applying a coating comprising beads onto the substrate to produce a coating layer containing beads.

6. The composite optical film as claimed in claim 5, wherein the beads have an average particle size in the range from 1 μm to 50 μm.

7. The composite optical film as claimed in claim 5, wherein the beads have an average particle size in the range from 3 μm to 10 μm.

8. The composite optical film as claimed in claim 5, wherein the beads are selected from the group consisting of glass beads, metal oxide beads, plastic beads, and a mixture thereof.

9. The composite optical film as claimed in claim 8, wherein the beads are plastic beads selected from the group consisting of acrylate resin, styrene resin, urethane resin, silicone resin, and a mixture thereof.

10. The composite optical film as claimed in claim 5, wherein the beads have a refractive index of 1.3 to 2.5.

11. The composite optical film as claimed in claim 10, wherein the beads have a refractive index of 1.4 to 1.6.

12. The composite optical film as claimed in claim 1, wherein the structured surface is formed by laminating one or more micro-structure layers on one side of the substrate.

13. The composite optical film as claimed in claim 1, wherein the structured surface is formed by applying a resin coating onto one side of the substrate so as to form a structured surface comprising a plurality of micro-structures having light-converging effect.

14. The composite optical film as claimed in claim 13, wherein the resin coating comprises a UV curable resin.

15. The composite optical film as claimed in claim 14, wherein the UV curable resin is selected from the group consisting of a (meth)acrylate resin, a urethane acrylate resin, a polyester acrylate resin, an epoxy acrylate resin, and a mixture thereof.

16. The composite optical film as claimed in claim 1, wherein the structured surface have the micro-structures selected from the group consisting of regularly or irregularly arranged columnar structures, conical structures, solid angle structures, orange-segment like structures, lens-like structures, and capsule-like structures, and a combination thereof.

17. The composite optical film as claimed in claim 16, wherein the columnar structures are prism columnar structures, arc columnar structures, or a combination thereof.

18. The composite optical film as claimed in claim 17, wherein the columnar structures are prism columnar structures having apex angles in the range from 40° and 120°.

19. The composite optical film as claimed in claim 1, further comprising a scratch-resistant layer.

20. The composite optical film as claimed in claim 19, wherein the scratch-resistant layer comprises beads.
